(19) United States
(12) Patent Application Publication
(10) Pub. No.: US 2025/0391960 A1
(43) Pub. Date: Dec. 25, 2025

(54) SECONDARY BATTERY

(71) Applicant: Prime Planet Energy & Solutions, Inc., Tokyo (JP)

(72) Inventor: Yozo UCHIDA, Toyota-shi (JP)

(21) Appl. No.: 19/235,580

(22) Filed: Jun. 12, 2025

(30) Foreign Application Priority Data
Jun. 20, 2024 (JP) 2024-099421

(51) Int. Cl. H01M 50/103; H01M 4/134; H01M 50/183

(52) U.S. Cl. CPC H01M 50/103; H01M 4/134; H01M 50/183

(57) ABSTRACT

The secondary battery includes a battery case. This battery case includes a battery case main body and includes a sealing plate. This battery case main body includes a pair of wide width side surfaces that are opposed mutually, and includes a pair of narrow width side surfaces that are opposed mutually. The sealing plate includes a peripheral part and a central part that is flat. Regarding the sealing plate, an end surface of a peripheral edge of the peripheral part is joined to end surfaces of the pair of wide width side surfaces and joined to end surfaces of the pair of narrow width side surfaces. The peripheral part is bent over a whole circumference of it to make the battery outer surface side from the central part of the sealing plate toward the end surface of the peripheral edge of the peripheral part be a convex surface.

### CROSS REFERENCE TO RELATED APPLICATIONS

The present application claims the priority based on Japanese Patent Application No. 2024-099421 filed on Jun. 20, 2024. The entire contents of the prior application are incorporated in the present specification by reference.

### BACKGROUND

### 1. Technical Field

The present disclosure relates to a secondary battery.

### 2. Background

Regarding the secondary battery, such as lithium ion secondary battery, an expansion of an electrode assembly is caused in response to a repeat of an electrical charge and an electrical discharge, and then a battery case might be broken. Thus, in anticipation of the expansion of the electrode assembly, research is conducted for a secondary battery in which a capacity at an inside of a battery can be increased.

As this kind of technique, for example, Japanese Patent Application Publication No. 2006-338992 describes a secondary battery that is configured to make a thin portion of a plate thickness of a battery case central part absorb the expansion of the electrode assembly, so as to inhibit the breakage of the battery case.

In addition, Japanese Patent Application Publication No. 2005-294012 describes a secondary battery in which a curved surface directed to a height direction of the battery is provided on a sealing plate, so as to inhibit the breakage of the battery case caused by the expansion of the electrode assembly.

Anyway, from a perspective of achieving a higher capacity of the secondary battery, a development of the secondary battery, in which a Si or a Si chemical compound is used as a negative electrode active material, is progressing. However, in a situation where the Si or the Si chemical compound is used as a negative electrode active material, in comparison with a situation where the other negative electrode active material, such as graphite, is used, the expansion of the electrode assembly in response to the electric charge and the electric discharge of the secondary battery is significantly caused. Thus, in the secondary battery, it is required to further enhance a reliability with respect to the expansion of the electrode assembly.

### SUMMARY

The present disclosure has been made in view of the above-described circumstances, and a main object of it is to provide a secondary battery having a high reliability with respect to the expansion of the electrode assembly in response to the electric charge and the electric discharge.

In order to solve the above-described circumstances, the herein disclosed secondary battery includes an electrode assembly, and a battery case that is configured to accommodate the electrode assembly. The battery case includes a battery case main body that is formed in a hexagonal shape including an opening part, and a sealing plate that is configured to seal the opening part of the battery case main body. The battery case main body includes a pair of wide width side surfaces that are opposed mutually and that are formed in rectangular shapes, and a pair of narrow width side surfaces that are opposed mutually and that are formed in rectangular shapes. Each of said one or two sealing plates includes a peripheral part and a central part that is flat and that is surrounded by the peripheral part, an end surface of a peripheral edge of the peripheral part is joined to end surfaces of the pair of wide width side surfaces and end surfaces of the pair of narrow width side surfaces, and the peripheral part is bent over a whole circumference of the peripheral part to make a battery outer surface side from the central part of the sealing plate toward the peripheral edge end surface be a convex surface.

According to the secondary battery having the configuration described above, a R shape (a bent shape) is provided on the sealing plate, and thus it is possible to relieve a stress concentration at a joint portion of the battery case main body with the sealing plate although the stress at the electrode assembly expansion time tends to concentrate on the joint portion. Then, it is possible to inhibit the breakage of the battery case caused by the above-described expansion of the electrode assembly.

In one suitable aspect of the herein disclosed secondary battery, outer surfaces of the 4 side surfaces of the battery case main body and at least one of outer surfaces of the peripheral part of the sealing plate close to the end surfaces of the 4 side surfaces are joined mutually so as to be approximately flush with each other. By doing this, it is possible to further preferably implement integrating (equalizing) the battery case main body and the sealing plate, as the result, it is possible to suppress an uneven distribution of stress concentration portions at the electrode assembly expansion time, and thus it is possible to suitably implement inhibiting the breakage of the battery case.

One aspect of the herein disclosed secondary battery includes a battery case main body that is formed in a hexagonal shape in which one surface is an opening part, and includes a sealing plate that is configured to seal said one opening part of the battery case main body, and a surface being opposed to the opening part is treated as a bottom surface. By doing this, it is possible to suitably implement inhibiting the breakage of the battery case in which the positive electrode terminal and the negative electrode terminal are attached to the sealing plate being opposed to the bottom surface of the battery case.

In one suitable aspect of the herein disclosed secondary battery, the bottom surface includes a bottom surface peripheral part, and a bottom surface central part that is flat and that is surrounded by the bottom surface peripheral part. The bottom surface peripheral part is bent to rise in an upward direction of a case height direction which is a perpendicular direction from the bottom surface central part over a whole circumference of the bottom surface peripheral part, and is configured to continue to the pair of wide width side surfaces and the pair of narrow width side surfaces. By doing this, it is possible to further suitably implement inhibiting the breakage of the battery case in which the positive electrode and the negative electrode terminal are attached to the sealing plate being opposed to the bottom surface of the battery case.

In one suitable aspect of the herein disclosed secondary battery, the battery case includes a battery case main body that is formed in a hexagonal shape in which two surfaces are opening parts, and includes two sealing plates that are configured to seal the two opening parts of the battery case main body. A positive electrode terminal being electrically connected via a positive electrode current collector to a positive electrode of the electrode assembly is attached to a central part included by one of the sealing plates, and a negative electrode terminal being electrically connected via a negative electrode current collector to a negative electrode of the electrode assembly is attached to a central part included by the other one of the sealing plates. By doing this, it is possible to suitably implement inhibiting the breakage of the secondary battery in which the positive electrode and the negative electrode terminal are attached in a direction perpendicular to a laminate direction of the electrode assembly.

In one suitable aspect of the herein disclosed secondary battery, the electrode assembly contains a Si or a Si chemical compound as a negative electrode active material.

From a perspective of achieving the higher capacity of the battery, it is desired to use the Si or the Si chemical compound (hereinafter, collectively referred to as “Si-type negative electrode active material”) whose capacity per unit volume is larger than a conventional graphite-type negative electrode active material, but there is a circumstance of a high expansion rate at the electric charge and electric discharge time. Regarding the herein disclosed secondary battery, an expansion resistance performance of the battery case is high as described above, and thus it is possible to suitably use the Si-type negative electrode active material as the negative electrode active material. Therefore, according to the herein disclosed technique, it is possible to provide a high performance secondary battery.

### BRIEF DESCRIPTION OF THE DRAWINGS

FIG. 1 is a perspective view that schematically shows a secondary battery according to a first embodiment.

FIG. 2 is a side view that schematically shows a battery case of the secondary battery according to the first embodiment.

FIG. 3 is a partially enlarged view of the battery case of the secondary battery according to the first embodiment.

FIG. 4 is a cross-section view that schematically shows a vicinity of a bottom surface of the secondary battery according to a second embodiment.

FIG. 5 is a cross-section view that schematically shows a side surface of the secondary battery 100 according to a third embodiment.

FIG. 6 is a view that schematically shows a configuration of an electrode assembly (a wound electrode assembly) of the secondary battery.

### DETAILED DESCRIPTION

Hereinbelow, the present disclosure will be described in detail. Incidentally, the matters being other than matters particularly mentioned in this specification and being required for performing the herein disclosed technique can be grasped as design matters of those skilled in the art based on the related art in the present field. The herein disclosed technique can be executed based on the contents disclosed in the present specification, and the technical common sense in the present field. Additionally, in drawings explained by the present specification, the members/parts providing the same effect are provided with the same numerals and signs so as to be explained, and overlapping explanation might be omitted or simplified. In addition, the dimensional relation (a length, a width, a thickness, or the like) of each drawing does not always reflect the actual dimensional relation.

In the present specification, “secondary battery” is a term denoting a general electricity storage device that is capable of repeatedly performing an electric charge and an electric discharge in response to movement of a charge carrier between a positive electrode and a negative electrode, and is a concept semantically covering a so-called storage battery (a chemical battery), such as lithium ion secondary battery and sodium ion secondary battery, and a capacitor (a physical battery), such as lithium ion capacitor (LIC). Below, each of main configuration materials of the secondary battery in accordance with the present disclosure will be described. Incidentally, as a configuration material of the secondary battery not described herein, a conventionally known configuration material can be used.

### 1. Whole Configuration of Secondary Battery

FIG. 1 is a perspective view of a secondary battery (a lithium ion secondary battery) 100 in accordance with a first embodiment. The secondary battery 100 according to the first embodiment is configured with a battery case 10 and an electrode assembly 20 (not shown in drawings) that is accommodated at an inside of this battery case 10, and this battery case 10 includes a box-shaped battery case main body 11 that is formed in a hexagonal shape whose one surface or two surfaces are opening parts, and includes one or two sealing plates 14 that are configured to respectively seal said one or two opening parts of the battery case main body 11.

Then, it is characterized in that at least 1 corner part 12 is formed in a R shape.

The sealing plate 14 is provided with a liquid injection port 15, a sealing part 16, a gas exhausting valve 17, and two terminal taking out holes (not shown in drawings). The liquid injection hole 15 is for injecting an electrolytic solution. The liquid injection hole 15 is sealed by the sealing member 16. The gas exhausting valve 17 is configured to be broken when a pressure inside the box-shaped battery case 10 becomes equal to or more than a predetermined value, so as to exhaust gas inside the battery case 10 to an outside.

Two terminal taking out holes are respectively formed at both ends of the battery case 10 in a long side direction Y. The terminal taking out hole is configured to penetrate the sealing plate 14 in a vertical direction Z. The terminal taking out holes have inner diameters whose sizes can be respectively to allow making the positive electrode terminal 30 and the negative electrode terminal 40, before attached to the sealing plate 14 (before a caulking process), be inserted into the holes.

In the secondary battery 100, for inhibiting a continuity between arbitrary members, various insulating members are attached between these members. A material of this insulating member is not particularly restricted, if it has a predetermined insulating property. As an example, it is possible to use a synthetic resin material, such as polyolefin type resin (example: polypropylene (PP), polyethylene (PE)), fluorine type resin (example: perfluoro alkoxy alkane (PFA), and polytetrafluoroethylene (PTFE)).

### 1.1 Box-Shaped Battery Case

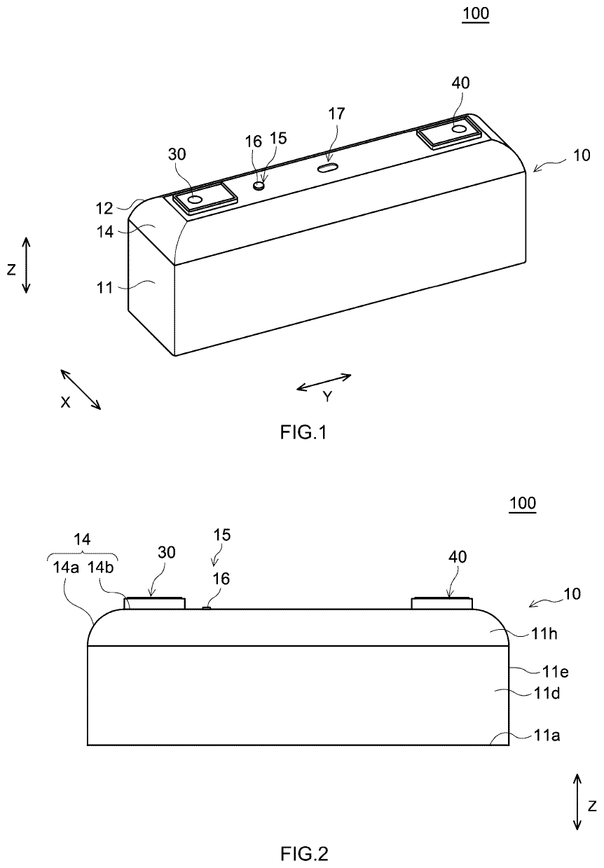

FIG. 2 is a side view that schematically shows a battery case of a secondary battery according to a first embodiment. In the present embodiment, a surface opposed to an opening 11h is treated as a bottom surface 11a. A material of the battery case 10 might be the same as a material conventionally used, and is not particularly restricted. It is preferable that the box-shaped battery case 10 is made of metal, and it is further preferable that, for example, the battery case is made of aluminum, aluminum alloy, iron, iron alloy, or the like.

As shown in this drawing, the box-shaped battery case main body 11 includes a pair of wide width side surfaces 11d that are formed in rectangular shapes and are opposed mutually, and includes a pair of narrow width side surfaces 11e that are formed in rectangular shapes and are opposed mutually. The wide width side surface 11d has an area comparatively larger than the narrow width side surface 11e. In the present specification, a direction in which the wide width side surfaces 11d are opposed is a thickness direction of the battery (a x direction of FIG. 1), a direction in which the narrow width side surfaces 11e are opposed is a width direction of the battery (the y direction of FIG. 1), and a direction in which the side surfaces 11d, 11e stand to extend from the bottom surface 11a of the battery case main body 10 is a height direction of the battery (the z direction of FIG. 1).

In the present embodiment, each of one or two sealing plates 14, which is joined to the battery case main body 11 so as to construct the battery case 10, includes a peripheral part 14a, and a central part 14b that is flat and that is surrounded by this peripheral part 14a.

Two terminal taking out holes are respectively formed at both ends of the sealing plate 14 in the long side direction Y. The terminal taking out holes are configured to penetrate the sealing plate 14 in the vertical direction Z. The terminal taking out holes have inner diameters whose sizes are respectively to allow making the positive electrode terminal 30 and the negative electrode terminal 40, before attached to the sealing plate 14 (before a caulking process), be inserted into the holes.

Regarding the sealing plate 14, an end surface at a peripheral edge of the peripheral part 14a is joined to end surfaces of the pair of wide width side surfaces 11d and to end surfaces of the pair of narrow width side surfaces 11e. By joining (for example, welding and joining) the sealing plate 14 to the peripheral edge of the opening 11h of the box-shaped battery case main body 11, an integration is implemented. The battery case 10 is airtightly sealed (hermetically sealed).

The peripheral part 14a of the sealing plate 14 is bent so as to make a battery outer surface side become a convex surface from the central part 14b of the sealing plate 14 to an end surface of the peripheral edge over a whole circumference of it.

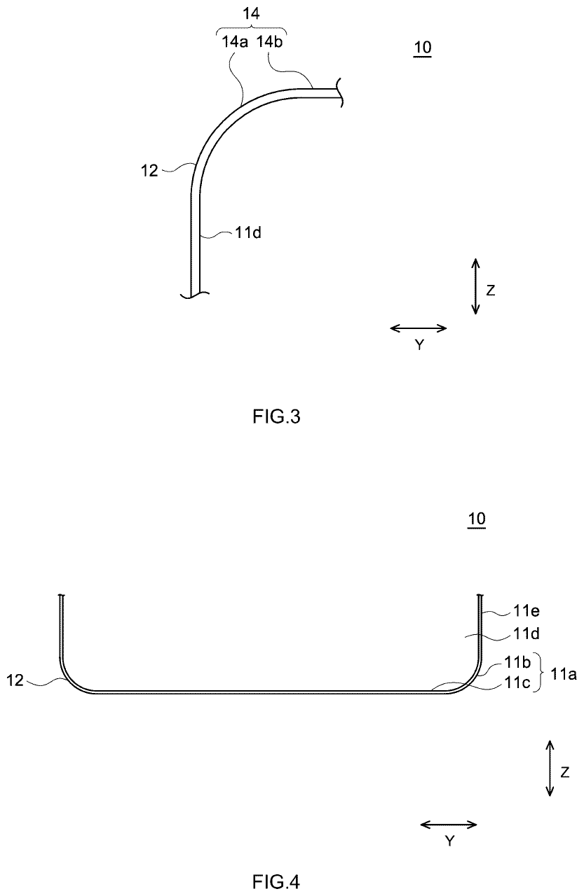

FIG. 3 is a partially enlarged view of the battery case of the secondary battery according to the first embodiment. Regarding the secondary battery according to the present embodiment, as shown in FIG. 3, an outer surface of 4 side surfaces of the battery case main body 11 and at least 1 of outer surfaces of the peripheral part 14a configured to cover the central part 14b of the sealing plate 14 close to end surfaces of said 4 side surfaces 11d and 11e (not shown in drawings) are joined mutually so as to make them be approximately flush. By doing this, as described later, it is possible to implement suppressing the breakage of the battery case according to the present disclosure.

FIG. 4 is a cross-section view that schematically shows a vicinity of a bottom surface of the secondary battery according to the second embodiment. In the present view, only the bottom surface vicinity of the secondary battery which is a feature portion of the present embodiment is drawn, and the other portions are omitted because they are the same as the configuration of the battery of the above described first embodiment.

As shown in FIG. 4, the bottom surface 11a of the battery case main body 11 includes a bottom surface peripheral part 11b and a bottom surface central part 11c that is flat and that is surrounded by this bottom surface peripheral part 11b, and the bottom surface peripheral part 11b is bent over a whole circumference to rise from the bottom surface central part 11c to an upward in a case height direction, so as to make it continue to the pair of wide width side surfaces 11d and the pair of narrow width side surfaces 11e. By doing this, as described later, it is possible to suitably implement suppressing the breakage of the battery case according to the present disclosure.

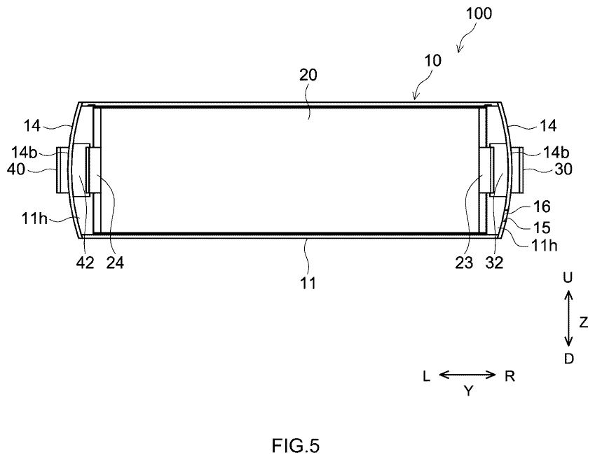

FIG. 5 is a cross-section view that schematically shows a side surface of the secondary battery 100 according to a third embodiment. As shown in FIG. 5, the battery case 10 includes the box-shaped battery case main body 11 formed in a hexagonal shape in which two of surfaces are openings 11h, and includes two sealing plates 14 configured to seal said two openings 11h of this battery case main body 11. At a central part 14b of one of the sealing plates 14, the positive electrode terminal 30 is attached which is electrically connected to the positive electrode 22 of the electrode assembly 20 via the positive electrode current collector 32, and at the other one, the negative electrode terminal 40 is attached which is electrically connected to the negative electrode 24 of the electrode assembly 20 via the negative electrode current collector 42. By doing this, it is possible to suitably implement inhibiting the breakage of the secondary battery in which the positive electrode terminal and the negative electrode terminal are attached in a direction perpendicular to a laminate direction of the electrode assembly.

### 1.2 Electrode Assembly

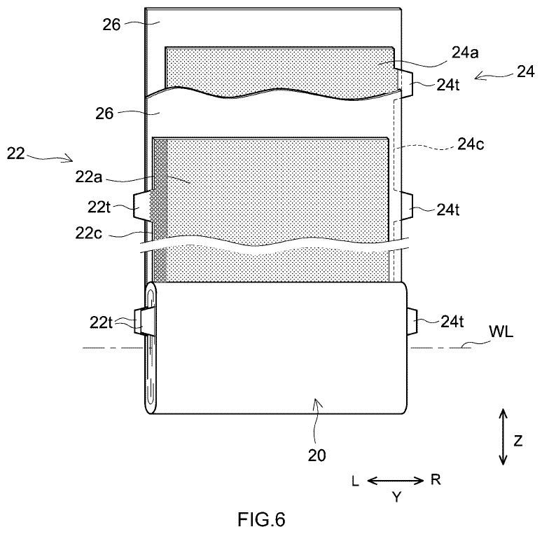

FIG. 6 is a schematic view that shows a configuration of the electrode assembly 20. The electrode assembly 20 includes the positive electrode 22 and the negative electrode 24. The electrode assembly 20 herein is a wound electrode assembly formed in a flat shape which is configured by laminating the positive electrode 22 formed in a strip-like shape and the negative electrode 24 formed in a strip-like shape via the separator 26 formed in a strip-like shape and then by winding the resultant therein about a winding axis WL as a center. However, the electrode assembly 20 might be a laminate electrode body in which plural square shaped (typically, rectangular) positive electrodes and plural square shaped (typically, rectangular) negative electrodes are stacked in a state of being insulated. Incidentally, a wording “thickness direction of the electrode assembly” in the present specification represents a laminate direction in which the electrode plate is laminated. Regarding the electrode assembly 20 in the present embodiment, an opposed direction (the X direction of FIG. 4) of the wide width surfaces being orthogonal to a laminate end surface is referred to as the thickness direction of the electrode assembly. In the present embodiment, the thickness direction of the battery and the thickness direction of the electrode assembly coincide.

The positive electrode 22 includes, as shown in FIG. 6, a positive electrode substrate 22c and a positive electrode active material layer 22a that is formed on at least one surface (here, both surfaces) of the positive electrode substrate 22c.

The positive electrode substrate 22c is formed in a strip-like shape. The positive electrode substrate 22c consists of, for example, an electrically conductive metal, such as aluminum, aluminum alloy, and stainless steel. The positive electrode substrate 22c herein is a metal foil, in particular, an aluminum foil.

The positive electrode active material layer 22a is, as shown in FIG. 6, provided in a strip-like shape along a longitudinal direction of the positive electrode substrate 22c formed in a strip-like shape. The positive electrode active material layer 22a contains a positive electrode active material that can reversibly store and release a charge carrier. As the positive electrode active material, it is preferable to contain at least one kind among at least Ni, Co, and Mn, and thus it is possible to use, for example, a lithium-transition metal complex oxide, such as lithium-nickel-cobalt-manganese composite oxide. When a total solid content of the positive electrode active material layer 22a is treated as 100 mass %, the positive electrode active material might occupy approximately 80 mass % or more, typically 90 mass % or more, or, for example, 95 mass % or more. The positive electrode active material layer 22a might contain an arbitrary component other than the positive electrode active material, for example, an electrically conducting material, a binder, various additive components, or the like. As the electrically conducting material, it is possible to use, for example, a carbon material, such as carbon black (for example, acetylene black (AB)). As the binder, it is possible to use, for example, PVdF, or the like.

As shown in FIG. 6, plural positive electrode tabs 22t are configured to protrude from end parts of the electrode assembly 20 in the long side direction Y. In addition, the plural positive electrode tabs 22t are provided at intervals along a longitudinal direction of the positive electrode 22 formed in the strip-like shape. A shape of the tab herein is set to be rectangular, but it might be a shape different from it (for example, a trapezoidal shape), or the like. At least a part of the positive electrode tab 22t is provided with an area on which the positive electrode active material layer 22a is not formed and on which the positive electrode substrate 22c is exposed.

The negative electrode 24 includes, as shown in FIG. 6, a negative electrode substrate 24c, and a negative electrode active material layer 24a that is formed on at least one surface of the negative electrode substrate 24c (here, both surfaces).

The negative electrode substrate 24c is formed in a strip-like shape. The negative electrode substrate 24c consists of, for example, an electrically conductive metal, such as copper, copper alloy, nickel, and stainless steel. The negative electrode substrate 24c herein is a metal foil, in particular, a copper foil.

The negative electrode active material layer 24a is provided in a strip-like shape along the longitudinal direction of the negative electrode substrate 24c formed in the strip-like shape. The negative electrode active material layer 24a contains a negative electrode active material (for example, a carbon material, such as graphite, or Si chemical compound, such as Si and SiO) that can reversibly store and release a charge carrier. As the Si chemical compound, it is possible to use a silicon oxide represented by SiOₓ (0.05<x 1.95), a lithium silicon oxide represented by LiₓSi_{y}O_{z} (x, y, and z independently satisfy 0≤x, y, z≤1), a lithium-containing lithium-silicon alloy represented by Li₂₁Si₅, or the like. When a total solid content of the negative electrode active material layer 24a is treated as 100 mass %, the negative electrode active material might occupy approximately 80 mass % or more, typically 90 mass % or more, or, for example, 95 mass % or more. The negative electrode active material layer 24a might contain an arbitrary component other than the negative electrode active material, for example, a binder, a dispersing agent, various additive components, or the like. As the binder, for example, rubbers, such as styrene butadiene rubber (SBR) can be used. As the dispersing agent, for example, celluloses, such as carboxymethyl cellulose (CMC) can be used.

In a situation where especially the Si or the Si chemical compound is used as the negative electrode active material, an insertion/extraction amount of the charge carrier (a lithium ion, or the like) per unit area is large, and thus it is possible to provide a high performance secondary battery that can achieve a higher capacity. In the situation where the Si or the Si chemical compound is used as the negative electrode active material, a volume change in response to the insertion/extraction of the charge carrier (the lithium ion, or the like) is large, thus an expansion of the electrode assembly according to the electric charge and electric discharge significantly occurs, and as the result, the breakage of the battery case is easily caused. However, the secondary battery according to the present disclosure can suitably implement inhibiting the breakage of the battery case according to the expansion of the electrode assembly in response to the electric charge and electric discharge, and thus it is possible to use the Si or the Si chemical compound as the negative electrode active material.

As shown in FIG. 6, plural negative electrode tabs 24t are configured to protrude from an end part of the electrode assembly 20 in the long side direction Y. In addition, the plural negative electrode tabs 24t are provided at the intervals along the longitudinal direction of the negative electrode 24 formed in the strip-like shape. A shape of the tab herein is set to be rectangular, but it is possible to make the shape of the tab be variously a shape different from it (for example, a trapezoidal shape), or the like. At least a part of the negative electrode tab 24t is provided with an area on which the negative electrode active material layer 24a is not formed and on which the negative electrode substrate 24c is exposed.

The separator 26 is a member that is configured to establish an insulation between the positive electrode active material layer 22a of the positive electrode 22 and the negative electrode active material layer 24a of the negative electrode 24. As the separator 26, for example, it is possible to suitably use a porous resin sheet that consists of a polyolefin-type resin, such as polyethylene (PE) and polypropylene (PP). In addition, regarding the separator 26, a heat resistance layer (HRL) containing an inorganic filler might be provided on a surface of this resin sheet. As the inorganic filler, for example, it is possible to use alumina, boehmite, aluminum hydroxide, titania, or the like. In addition, it is preferable that an adhesion layers provided with on a surface at one side or surfaces at both sides of the separator 26. The adhesion layer can enhance an adhesive property with the positive electrode active material layer or the negative electrode active material layer that comes into contact with it. The adhesion layer contains, for example, polyvinylidene fluoride (PVdF) as the adhesion component. In addition, the adhesion layer can contain an inorganic particle, such as alumina and boehmite. The adhesion layer might be provided on a surface of the resin sheet described above, or might be provided on a surface of the HRL.

### 2. Expansion of Electrode Assembly and Suppression of Battery Case Breakage

As described above, in this kind of secondary battery, the expansion of the electrode assembly accommodated at the inside of the battery case could be caused accordingly to the electric charge and electric discharge. Then, an excessive expansion of the electrode assembly could cause the breakage of the battery case. Especially, in the situation where the Si or the Si chemical compound is used as the negative electrode active material, a volume change in response to the insertion/extraction of the charge carrier (the lithium ion, or the like) is large, and thus the excessive expansion of the electrode assembly according to the electric charge and electric discharge of the secondary battery described above tends to be easily caused further than a situation where the other kind of negative electrode active material (for example, a graphite) is used.

Therefore, regarding the battery case used for the herein disclosed secondary battery, a feature as described later is applied.

### (1) Shape of Corner Part (R Part) of Box-Shaped Battery Case

In the secondary battery according to the first embodiment, as shown by FIG. 1, at least one of corner parts 12 of the battery case 10 is formed in a bent shape, in other words, an R shape. By doing this, at the expansion time of the electrode assembly 20 (not shown), it is possible to relieve a stress concentration at the corner part 12 of the battery case 10, and thus it is possible to inhibit the battery case 10 from being broken.

Incidentally, in the secondary battery according to the second embodiment, as shown by FIG. 4, the corner part 12 at the bottom surface 11a side of the battery case 10 is formed in the R shape. By doing this, it is possible to implement the above-described effect even at the bottom surface 11a side of the battery case 10, and thus it is possible to further suitably implement suppressing the breakage of the battery case 10.

In the secondary battery according to the third embodiment, similarly to the secondary battery according to the second embodiment, it is possible to implement suppressing the breakage of the battery case 10 on two surfaces of the battery case 10. Regarding a point different from the secondary battery according to the second embodiment, surfaces to which the positive electrode terminal and the negative electrode terminal are attached are different.

Here, as a degree of the R shape (a bent degree), although being not particularly restricted by a size of the battery, it is suitable to be equal to or more than R5, it is preferable to be equal to or more than R8, or it is further preferable to be equal to or more than R10. On the other hand, if the R shape is too gentle, there is a fear that the herein disclosed effect cannot be implemented, thus it is suitable to be equal to or less than R50, it is preferable to be equal to or less than R40, or it is further preferable to be equal to or less than R30 (for example, R20±5). Here, the number described next to the R represents a radius (mm) of this R.

There are some conventional secondary batteries, in which the corner part of the battery case is formed as an apex. It can be said that this kind of embodiment is outside a scope of a technical idea of the battery case according to the present disclosure. Then, the stress is concentrated at the corner part of the battery case when the electrode assembly is expanded, and therefore the battery case can be easily broken.

### (2) Position of Joint Part of Battery Case

As shown by FIG. 3, in one suitable aspect of the secondary battery according to the present disclosure, an outer case 11 and the sealing plate 14 are joined to make the outer side surface (the wide width side surface 11d in the present drawing) of the battery case main body 11 be approximately flush with the outer side surface of the peripheral part 14a of the sealing plate 14. By doing this, it is possible to implement integrating (equalizing) the battery case main body and the sealing plate in a better condition, it is possible as the result to suppress an uneven distribution of stress concentration portions at the electrode assembly expansion time, and thus it is possible to inhibit the battery case 10 from being broken.

On the other hand, there are some conventional secondary batteries, in which all of the joint parts of the outer case with the sealing plate are formed at positions corresponding to the corner parts of the battery case. It can be said that this kind of embodiment is outside the scope of the technical idea of the box-shaped battery case according to the present disclosure. Then, the stress is concentrated at the joint part of the battery case when the electrode assembly is expanded, and therefore the battery case can be easily broken.

Regarding the secondary battery according to the present disclosure, by independently including the above-described (1) the shape of the corner part of the battery case and (2) a joint aspect of the battery case main body with the sealing plate or by combining them, it is possible to suitably implement suppressing the breakage of the battery case 10 caused by the expansion of the electrode assembly 20.

Above, a detailed description has been given by way of specific embodiments, which are merely illustrative, and is not intended to limit the scope of the appended claims. The technology according to the appended claims includes various modifications and changes of the above-described embodiments.

As described above, the present specification contains disclosures recited by items described below.

Item 1: A secondary battery, comprising:
an electrode assembly; and
a battery case that is configured to accommodate the electrode assembly,
wherein the battery case comprises:
   a battery case main body that is formed in a hexagonal shape comprising an opening part; and
   a sealing plate that is configured to seal the opening part of the battery case main body,
the battery case main body comprises:
   a pair of wide width side surfaces that are opposed mutually and that are formed in rectangular shapes; and
   a pair of narrow width side surfaces that are opposed mutually and that are formed in rectangular shapes,
each of said one or two sealing plates comprises a peripheral part and a central part that is flat and that is surrounded by the peripheral part,
an end surface of a peripheral edge of the peripheral part of the sealing plate being joined to end surfaces of the pair of wide width side surfaces and joined to end surfaces of the pair of narrow width side surfaces, and
the peripheral part is bent over a whole circumference of the peripheral part to make a battery outer surface side from the central part of the sealing plate toward the end surface of the peripheral edge be a convex surface.

Item 2: The secondary battery recited by Item 1, wherein
outer surfaces of the 4 side surfaces of the battery case and at least one of outer surfaces of the peripheral part of the sealing plate close to the end surfaces of the 4 side surfaces are joined mutually so as to be approximately flush with each other.

Item 3: The secondary battery recited by Item 1 or 2, wherein
the battery case comprises:
   a battery case main body that is formed in a hexagonal shape in which one surface is an opening part; and
   a sealing plate that is configured to seal said one opening part of the battery case main body, and
a surface being opposed to the opening is treated as a bottom surface.

Item 4: The secondary battery recited by Item 3, wherein
the bottom surface comprises:
   a bottom surface peripheral part; and
   a bottom surface central part that is flat and that is surrounded by
the bottom surface peripheral part, and
the bottom surface peripheral part is bent to rise in an upward direction of a case height direction which is a perpendicular direction from the bottom surface central part over a whole circumference of the bottom surface peripheral part, and is configured to continue to the pair of wide width side surfaces and the pair of narrow width side surfaces.

Item 5: The secondary battery recited by Item 1 or 2, wherein
the battery case comprises:
   a battery case main body that is formed in a hexagonal shape in which two surfaces are opening parts; and
   two sealing plates that are configured to seal the two opening parts of the battery case main body,
a positive electrode terminal being electrically connected via a positive electrode current collector to a positive electrode of the electrode assembly is attached to a central part comprised by one of the sealing plates, and a negative electrode terminal being electrically connected via a negative electrode current collector to a negative electrode of the electrode assembly is attached to a central part comprised by the other one of the sealing plates.

Item 6: The secondary battery recited by any one of Items 1 to 5, wherein
the electrode assembly contains a Si or a Si chemical compound as a negative electrode active material.

### REFERENCE SIGNS LIST

10 Battery case
11 Battery case main body
11a Bottom surface
11b Bottom surface peripheral part
11c Bottom surface central part
11d Wide width side surface
11e Narrow width side surface
12 Corner part
14 Sealing plate
14a Peripheral part
14b Central part
20 Electrode assembly
22 Positive electrode
22a Positive electrode active material layer
22c Positive electrode substrate
22t Positive electrode tab
24 Negative electrode
24a Negative electrode active material layer
24c Negative electrode substrate
24t Negative electrode tab
26 Separator
30 Positive electrode terminal
40 Negative electrode terminal
100 Secondary battery

What is claimed is:

1. A secondary battery, comprising:
an electrode assembly; and
a battery case that is configured to accommodate the electrode assembly, wherein the battery case comprises:
a battery case main body that is formed in a hexagonal shape comprising an opening part; and
a sealing plate that is configured to seal the opening part of the battery case main body,
the battery case main body comprises:
a pair of wide width side surfaces that are opposed mutually and that are formed in rectangular shapes; and
a pair of narrow width side surfaces that are opposed mutually and that are formed in rectangular shapes,
each of said one or two sealing plates comprises a peripheral part and a central part that is flat and that is surrounded by the peripheral part,
an end surface of a peripheral edge of the peripheral part of the sealing plate being joined to end surfaces of the pair of wide width side surfaces and joined to end surfaces of the pair of narrow width side surfaces, and
the peripheral part is bent over a whole circumference of the peripheral part to make a battery outer surface side from the central part of the sealing plate toward the end surface of the peripheral edge be a convex surface.

2. The secondary battery according to claim 1, wherein
outer surfaces of the 4 side surfaces of the battery case main body and at least one of outer surfaces of the peripheral part of the sealing plate close to the end surfaces of the 4 side surfaces are joined mutually so as to be approximately flush with each other.

3. The secondary battery according to claim 1, wherein
the battery case comprises:
a battery case main body that is formed in a hexagonal shape in which one surface is an opening part; and a sealing plate that is configured to seal said one opening part of the battery case main body, and
a surface being opposed to the opening part is treated as a bottom surface.

4. The secondary battery according to claim 2, wherein
the battery case comprises:
a battery case main body that is formed in a hexagonal shape in which one surface is an opening part; and
a sealing plate that is configured to seal said one opening part of the battery case main body, and
a surface being opposed to the opening part is treated as a bottom surface.

5. The secondary battery according to claim 3, wherein
the bottom surface comprises:
a bottom surface peripheral part; and
a bottom surface central part that is flat and that is surrounded by the bottom surface peripheral part, and
the bottom surface peripheral part is bent to rise in an upward direction of a case height direction which is a perpendicular direction from the bottom surface central part over a whole circumference of the bottom surface peripheral part, and is configured to continue to the pair of wide width side surfaces and the pair of narrow width side surfaces.

6. The secondary battery according to claim 4, wherein
the bottom surface comprises:
a bottom surface peripheral part; and
a bottom surface central part that is flat and that is surrounded by the bottom surface peripheral part, and
the bottom surface peripheral part is bent to rise in an upward direction of a case height direction which is a perpendicular direction from the bottom surface central part over a whole circumference of the bottom surface peripheral part, and is configured to continue to the pair of wide width side surfaces and the pair of narrow width side surfaces.

7. The secondary battery according to claim 1, wherein
the battery case comprises:
a battery case main body that is formed in a hexagonal shape in which two surfaces are opening parts; and
two sealing plates that are configured to seal the two opening parts of the battery case main body,
a positive electrode terminal being electrically connected via a positive electrode current collector to a positive electrode of the electrode assembly is attached to a central part comprised by one of the sealing plates, and a negative electrode terminal being electrically connected via a negative electrode current collector to a negative electrode of the electrode assembly is attached to a central part comprised by the other one of the sealing plates.

8. The secondary battery according to claim 2, wherein
the battery case comprises:
a battery case main body that is formed in a hexagonal shape in which two surfaces are opening parts; and
two sealing plates that are configured to seal the two opening parts of the battery case main body,
a positive electrode terminal being electrically connected via a positive electrode current collector to a positive electrode of the electrode assembly is attached to a central part comprised by one of the sealing plates, and a negative electrode terminal being electrically connected via a negative electrode current collector to a negative electrode of the electrode assembly is attached to a central part comprised by the other one of the sealing plates.

9. The secondary battery according to claim 1, wherein
the electrode assembly contains a Si or a Si chemical compound as a negative electrode active material.

10. The secondary battery according to claim 2, wherein
the electrode assembly contains a Si or a Si chemical compound as a negative electrode active material.
